(19) United States
(12) Patent Application Publication
(10) Pub. No.: US 2009/0192876 A1
(43) Pub. Date: Jul. 30, 2009

(54) METHODS AND SYSTEMS FOR PROVIDING A PAYMENT CARD PROGRAM DIRECTED TO EMPTY NESTERS

(76) Inventors: Sruba De, Houston, TX (US); Anant Nambiar, Larchmont, NY (US); Sheryl Sleeva, Norwalk, CT (US); Lauren Stephens, Darien, CT (US); Marc Del Bene, Darien, CT (US); Marianne Iannace, North Salem, NY (US); Trina Reuben-Williams, Danbury, CT (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 12/323,795

(22) Filed: Nov. 26, 2008

Related U.S. Application Data
(60) Provisional application No. 61/024,613, filed on Jan. 30, 2008.
(60) Provisional application No. 61/024,713, filed on Jan. 30, 2008.

(51) Int. Cl. G06Q 30/00; G06K 5/00; G06Q 40/00

(52) U.S. Cl. 705/10; 235/380; 705/14

(57) ABSTRACT

A computer-based method for enrolling financial transaction cardholders into a payment card program that includes features that are directed to an empty nester segment of society is described. The method includes creating at least one spending profile representing an empty nester target group. The empty nester target group includes transaction cardholders within the empty nester segment of society targeted for receiving a marketing campaign. The method also includes storing in the database transaction data for transaction card accounts, identifying cardholders included within the empty nester target group by comparing the transaction data to the at least one empty nester spending profile, and offering a payment card program having at least one rewards feature directed to the empty nester segment of society to the cardholders identified as being within the empty nester target group.

### CROSS REFERENCE TO RELATED APPLICATIONS

This application claims the priority of Provisional Patent Application Ser. No. 61/024,613 and Provisional Patent Application Ser. No. 61/024,713, both of which were filed on Jan. 30, 2008, and both of which are hereby incorporated by reference in their entirety.

### BACKGROUND OF THE INVENTION

The field of the invention relates generally to providing a payment card program having features directed to a certain segment of society and, more particularly, to network-based methods and systems for enrolling a user into a payment card program that includes rewards features that are directed to an empty nester segment of society.

Historically, the use of “charge” or transaction cards or payment cards for consumer transaction payments was at most regional and based on relationships between local credit or debit card issuing banks and various local merchants. The transaction card industry has since evolved with the issuing banks forming associations or networks (e.g., MasterCard®) and involving third party transaction processing companies (e.g., “Merchant Acquirers”) to enable cardholders to widely use transaction cards at any merchant's establishment, regardless of the merchant's banking relationship with the card issuer. (MasterCard is a registered trademark of MasterCard International Incorporated located in Purchase, N.Y.),

For example, FIG. 1 of the present application shows an exemplary multi-party payment card industry system for enabling payment-by-card transactions in which the merchants and issuer do not need to have a one-to-one special relationship. Yet, various scenarios exist in the payment-by-card industry today, where the card issuer has a special or customized relationship with a specific merchant, or group of merchants. These special or customized relationships may, for example, include private label programs, co-brand programs, proprietary card brands, rewards programs, and others. Rewards programs typically involve the award of rewards points to a consumer based upon certain incentivized actions taken by the consumer, such as the purchase of a certain value of goods or services from a particular merchant. Rewards points may be referred to by a particular rewards program as “rewards dollars,” “rewards miles,” or other descriptive names. The consumer then has the option of redeeming his or her accumulated rewards points according to rewards program rules to obtain better terms for a later transaction. The costs of providing such rewards program incentives to the cardholder may be borne solely by the issuer, jointly by the issuer and a merchant or third party, or solely by a merchant or third party, depending upon the type and sponsorship of the rewards program.

Matching a rewards program to a consumer or a specific group of consumers may be beneficial for the parties involved. Generally, consumers, and in some cases groups of consumers, are at different life stages and therefore have different spending behaviors. More specifically, consumers may be classified into life stage segments. A life stage segment is a group of consumers who are classified based on shared demographics and/or certain differentiating spending behaviors. Banks often have dozens, if not hundreds, of payment cards and financial transaction cards and other financial products designed to meet the needs of their consumers at various stages in their lives. Examples of financial products designed for specific life stage segments of society include student transaction cards and loans, banking products designed for young families, and retirement products for older customers.

However, a lack of detailed consumer information, coupled with an inability of these banks to share consumer data across departments, makes it difficult to match various life stage based financial products with the correct consumers. At least one result is that the banks waste resources on, poorly targeted promotional campaigns. Further, consumers get inundated with irrelevant offers that do not match their needs or preferences, often to the point that they will ignore offers that are relevant to their financial needs.

Banks would like to focus their services and desire to market those services more effectively than currently utilized marketing methods allow. In addition, it is desired that the services, and the marketing of such services, be accomplished without continuously gathering, storing, and updating consumer data. With such a system, the customers receive information and offers for products that are more relevant and useful to them. In such a system, banks identify a consumer's propensity to be in a given life stage using only the information from consumer transactions on their payment card, for example, credit cards and debit cards.

Once a bank or an issuer of a payment card identifies consumers included within a particular life stage segment, then the bank or card issuer must offer financial products or rewards programs that are targeted to the particular life stage segment. Unfortunately, at least some known segments of society have been completely left out of such payment card programs. These segments of society do not have payment card programs directed to them. One of these segments of society that does not have a payment card program specifically directed to them is the “empty nester” segment. An empty nester is defined to include a parent whose children have grown and left the parent's home, or a couple whose children have established separate households.

Moreover, at least some of the payment card programs, such as credit cards, that are marketed to a particular segment of society do not include many of the rewards features and capabilities that persons within that segment desire. Rather, these known programs are nothing more than a repackaging of existing programs, which are then marketed to a different segment of society. Such re-packaged programs do not address the needs of these segments of society. Accordingly, what is needed is a system for identifying consumers included within the empty nester segment of society and a payment card program having rewards features and capabilities that are specifically created and directed to the empty nester segment of society.

### BRIEF DESCRIPTION OF THE INVENTION

In one aspect, a computer-based method for enrolling financial transaction cardholders into a payment card program that includes features that are directed to an empty nester segment of society is provided. The method includes creating at least one spending profile representing an empty nester target group. The empty nester target group includes transaction cardholders within the empty nester segment of society targeted for receiving a marketing campaign. The method also includes storing in the database transaction data for transaction card accounts. The transaction data includes data relating to each cardholder associated with a transaction card account and purchases made by the cardholders using the corresponding transaction card. The method also includes identifying cardholders included within the empty nester target group by comparing the transaction data to the at least one empty nester spending profile, and offering a payment card program having at least one rewards feature directed to the empty nester segment of society to the cardholders identified as being within the empty nester target group.

In another aspect, a computer for enrolling financial transaction cardholders into a payment card program that includes features that are directed to an empty nester segment of society is provided. The computer is coupled to a database and configured to store in the database at least one spending profile representing the empty nester segment of society, and to store in the database transaction data for a plurality of financial transaction cardholders. The computer is also configured to identify which of the plurality of financial transaction cardholders are included within the empty nester segment of society by comparing the transaction data to the at least one spending profile. The computer is also configured to prompt a user to offer a payment card having at least one rewards feature directed to the empty nester segment of society to the cardholders identified as being within the empty nester segment of society, and to register each cardholder that accepts the payment card offering.

In another aspect, a network based system for enrolling financial transaction cardholders into a payment card program that includes features that are directed to an empty nester segment of society is provided. The system includes a client system, a centralized database for storing information, and a server system configured to be coupled to the client system and the database. The server system is further configured to store in the database at least one spending profile representing the empty nester segment of society, and store in the database transaction data for a plurality of financial transaction cardholders. The server system is further configured to identify which of the plurality of financial transaction cardholders are included within the empty nester segment of society by comparing the transaction data to the at least one spending profile and prompt a user to offer a payment card having at least one rewards feature directed to the empty nester segment of society to the cardholders identified as being within the empty nester segment of society. The server system is further configured to register each cardholder that accepts the payment card offering.

In still another aspect, a computer program embodied on a computer readable medium for enrolling financial transaction cardholders into a payment card program that includes features that are directed to an individual included in an empty nester life stage segment is provided. The program includes at least one code segment that utilizes survey result data received from a plurality of financial transaction cardholders to define an empty nester life stage segment, identifies survey result data that can be utilized as common variables between the survey result data and a database of financial transaction card transaction data, and defines a spending profile representing the empty nester life stage segment based on the common variables. The program also includes at least one code segment that creates a transaction data-based empty nest life stage model through a comparison of the defined spending profile to at least a portion of the financial transaction card transaction data, and utilizes the transaction data-based empty nest life stage model to identify a cardholder associated with the financial transaction card transaction data that is within the empty nester life stage segment.

### BRIEF DESCRIPTION OF THE DRAWINGS

FIG. 1 is a schematic diagram illustrating an exemplary multi-party payment card industry system for enabling ordinary payment-by-card transactions in which the merchants and issuer do not need to have a one-to-one special relationship.

FIG. 2 is a simplified block diagram of an exemplary embodiment of a server architecture of a system in accordance with one embodiment of the present invention.

FIG. 3 is an expanded block diagram of an exemplary embodiment of a server architecture of a system in accordance with one embodiment of the present invention.

FIG. 4 is a flow chart illustrating a life stage modeling process.

FIG. 5 is a high level process map that outlines development of life stage models.

FIG. 6 is a detailed flow chart illustrating the life stage modeling process shown in FIGS. 4 and 5.

FIG. 7 is a diagram showing key themes considered in developing a payment card having rewards features directed to an empty nester segment of society, in accordance with one embodiment of the present invention.

FIG. 8 is a more detailed diagram showing key themes considered in developing a payment card having rewards features directed to an empty nester segment of society, in accordance with one embodiment of the present invention.

FIG. 9 is a diagram showing financial uncertainty attitudes of consumers included within an empty nester segment of society that are considered in developing a payment card having rewards features directed to the empty nester segment of society, in accordance with one embodiment of the present invention.

FIG. 10 is a diagram showing financial uncertainty behaviors of consumers included within an empty nester segment of society that are considered in developing a payment card having rewards features directed to the empty nester segment of society, in accordance with one embodiment of the present invention.

FIG. 11 is a diagram showing renewed independence attitudes of consumers included within an empty nester segment of society that are considered in developing a payment card having rewards features directed to the empty nester segment of society, in accordance with one embodiment of the present invention.

FIG. 12 is a diagram showing pragmatic preparedness attitudes of consumers included within an empty nester segment of society that are considered in developing a payment card having rewards features directed to the empty nester segment of society, in accordance with one embodiment of the present invention.

FIG. 13 is a diagram showing remaining young and active attitudes of consumers included within an empty nester segment of society that are considered in developing a payment card having rewards features directed to the empty nester segment of society, in accordance with one embodiment of the present invention.

FIG. 14 is a diagram showing renewed independence behaviors of consumers included within an empty nester segment of society that are considered in developing a payment card having rewards features directed to the empty nester segment of society, in accordance with one embodiment of the present invention.

FIG. 15 is a diagram showing pragmatic preparedness behaviors of consumers included within an empty nester segment of society that are considered in developing a payment card having rewards features directed to the empty nester segment of society, in accordance with one embodiment of the present invention.

FIG. 16 is a diagram showing further pragmatic preparedness behaviors of consumers included within an empty nester segment of society that are considered in developing a payment card having rewards features directed to the empty nester segment of society, in accordance with one embodiment of the present invention.

### DETAILED DESCRIPTION OF THE INVENTION

The methods and systems described herein relate to a financial transaction card payment system, such as a credit card payment system using the MasterCard® interchange (MasterCard is a registered trademark of MasterCard International Incorporated located in Purchase, N.Y.). The MasterCard® interchange is a proprietary communications standard promulgated by MasterCard International Incorporated® for the exchange of financial transaction data between financial institutions that have registered with MasterCard International Incorporated®.

The life stage modeling systems and methods described herein are based on consumer research that profiles how consumers that are in different life stages (or life stage segments) utilize their payment (e.g., financial transaction) cards. One specific example of a life stage segment is an empty nester life stage segment. An empty nester is defined to include a parent whose children have grown and left the parent's home, or a couple whose children have established separate households. The data from the consumer research is used to create spending profiles that are associated with each life stage, including a spending profile for empty nesters. Examples of spending profiles for consumers in the empty nester life stage, and examples of how consumers in the empty nester life stage utilize their payment cards, are described below. The spending profiles are then leveraged to develop data models that sift through transaction data and sort consumers into life stages based on how they have used their payment cards. In a specific example, data models are developed to sift through transaction data to identify consumers who, based on payment card usage, are determined to likely be in the empty nester life stage.

The systems and processes described herein facilitate, for example, determination of a customer's propensity to be in a given life stage using a client system, automated extraction of information, and web-based reporting for internal and external system users. A technical effect of the systems and processes described herein include at least one of (a) defining one or more life stage segments using survey results received from a subset of customers that have an account related to a financial transaction card, (b) identifying self reported spending information in the survey results that can be used as a common variable between the survey results and a database of transactions related to the financial transaction card, (c) using a processing device to create and use a logistic regression model to link consumers to one or more of the defined life stage segments based on the database of transactions, (d) creating a behavioral model, based on transaction data, that predicts the probability that a consumer account is associated with a customer in a specific life stage segment, and (e) development of a process to apply the behavioral model, for example, in the marketing of financial products.

More specifically, described herein are exemplary embodiments of systems and processes identifying empty nesters by analyzing collected transactional data of consumers. The exemplary embodiments also provide a payment card program having rewards features and capabilities directed to an empty nester or a group of empty nesters. Furthermore, the exemplary systems and methods are used for enrolling a user into a payment card program that includes rewards features that are directed to an empty nester segment of society. The exemplary systems and methods are also used for processing a transaction using the empty nester payment card. Empty nesters form an important segment of the economy. For example, empty nesters oftentimes form a significant segment of the housing market, since they often seek to reduce the amount of housing space they occupy and are thus one source of demand for smaller housing units.

The exemplary systems and processes include a cardholder that utilizes a payment card to make a purchase from a merchant, wherein the merchant has registered with a bankcard network such that the purchase made by the cardholder using the payment card can be processed over the bankcard network. The payment card has associated therewith a financial account in a financial institution and one or more rewards features that are directed to empty nesters. The financial transaction payment system that processes the transaction includes a processing unit, an application program for execution on the processing unit, and a database for storing information relating to the cardholders, the rewards features associated with each cardholder's payment card, and other rewards data.

The payment card described herein has associated therewith certain rewards features that have been determined to be desirable by the empty nester segment of society because these rewards features address many of the needs of this particular segment of society. For example, research has indicated that certain themes are important to the empty nester segment of society. The payment card includes rewards features that address these themes. The themes that have been identified include at least: (1) Financial Uncertainty; (2) Pragmatic Preparedness; (3) Renewed Independence; and (4) Remaining Young and Active. Based on these themes, certain rewards features have been developed and associated with the payment card described herein. At least some of the rewards features associated with the payment card described herein include: (a) Health and Wellness (e.g., cardholders within the empty nester payment card program save money at thousands of fitness clubs, chiropractors, alternative health providers and weight loss facilities; (b) Prescription Discount Drug Program (e.g., cardholders save money on generic and brand name drugs at certain pre-designated pharmacy locations) (c) Health Discount Program (e.g., cardholders receive discounted access to leading programs including health, dental and vision care provider networks); (d) Travel Fare Alerts (e.g., cardholders receive email alerts when your chosen price becomes available on your selected routes); (e) Family Travel Planner (e.g., cardholders have access to dedicated specialists to help the cardholder plan trips); (f) Personal Assistant (e.g., cardholders are provided assistance for day chores and tasks); (g) Financial Consultant (e.g., cardholder receives financial advice from financial professionals); and (h) Special Occasion Reminders/Important Dates (e.g., cardholders receive email reminders of birthdays, anniversaries and other special dates as well as opportunity to purchase gift cards in advance).

The life stage modeling systems and processes described herein may be used to identify a group of consumers included within the empty nester segment of society. After identifying these empty nester consumers, another technical effect of the systems and processes described herein include at least one of (a) providing a financial transaction payment system that includes a processing unit, an application program for execution on the processing unit, and a database for storing information relating to cardholders, rewards features associated with each cardholder's payment card, and rewards data; (b) offering a payment card having at least one rewards feature directed to an empty nester segment of society, wherein the empty nester payment card has associated therewith a financial account in a financial institution, and wherein the rewards features include at least one of a health and wellness feature, a prescription discount drug program feature, a health discount program feature, a travel fare alerts feature, a family travel planner feature, a personal assistant feature, a financial consultant feature, and a special occasion reminder feature; (c) registering within the financial transaction payment system users that accept the payment card offering by storing in the database each empty nester cardholder and each rewards feature associated with each empty nester payment card; (d) engaging in a transaction by a cardholder using a payment card; (e) processing the transaction over the financial transaction payment system; (f) determining whether the cardholder engaging in the transaction is registered within the database as an empty nester cardholder and whether the payment card used has an empty nester rewards feature associated therewith; (g) updating the rewards data stored within the database to include the transaction if the cardholder is a registered empty nester cardholder; and (h) providing a reward to the empty nester cardholder based on the updated rewards data stored within the database.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

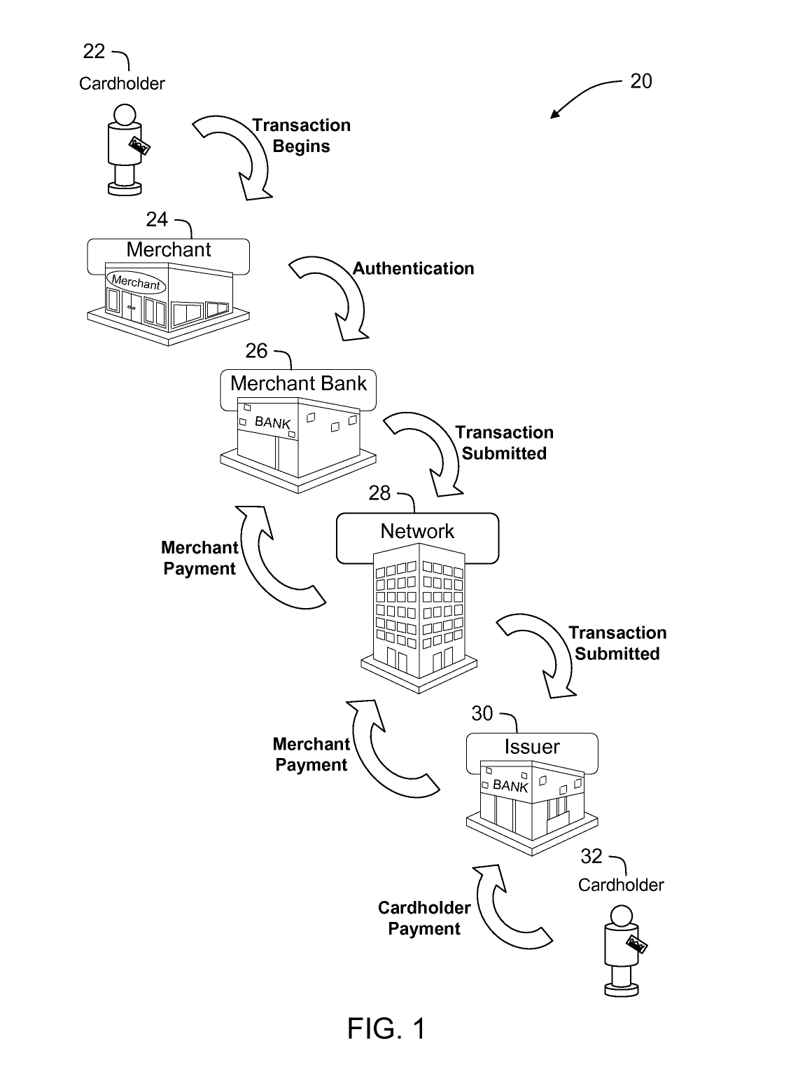

FIG. 1 is a schematic diagram 20 illustrating an exemplary multi-party payment card industry system for enabling ordinary payment-by-card transactions in which the merchants and issuer do not need to have a one-to-one special relationship. The present invention relates to a payment card system, such as a credit card payment system using the MasterCard® interchange network. The MasterCard® interchange network is a set proprietary communications standards promulgated by MasterCard International Incorporated® for the exchange of financial transaction data and settlement funds between financial institutions that are members of MasterCard International Incorporated®. (MasterCard is a registered trademark of MasterCard International Incorporated located in Purchase, N.Y.).

In a typical payment card system, a financial institution called the “issuer” issues a payment card, such as a credit card, to a consumer, who uses the payment card to tender payment for a purchase from a merchant. To accept payment with the payment card, the merchant must normally establish an account with a financial institution that is part of the financial payment system. This financial institution is usually called the “merchant bank” or the “acquiring bank” or “acquirer bank.” When a consumer 22 tenders payment for a purchase with a payment card (also known as a financial transaction card), the merchant 24 requests authorization from the merchant bank 26 for the amount of the purchase. The request may be performed over the telephone, but is usually performed through the use of a point-of-sale terminal, which reads the consumer's account information from the magnetic stripe or chip on the payment card and communicates electronically with the transaction processing computers of the merchant bank. Alternatively, a merchant bank may authorize a third party to perform transaction processing on its behalf. In this case, the point-of-sale terminal will be configured to communicate with the third party. Such a third party is usually called a “merchant processor” or an “acquiring processor” or a “third party processor.”

Using the interchange network 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge for a credit transaction is not posted immediately to a consumer's account because bankcard associations, such as MasterCard International Incorporated®, have promulgated rules that do not allow a merchant to charge, or “capture,” a transaction until goods are shipped or services are delivered. However, with respect to at least some debit card transactions, a charge may be posted at the time of the transaction. When a merchant ships or delivers the goods or services, the merchant captures the transaction by, for example, appropriate data entry procedures on the point-of-sale terminal. This may include bundling of approved transactions daily for standard retail purchases. If a consumer cancels a transaction before it is captured, a “void” is generated. If a consumer returns goods after the transaction has been captured, a “credit” is generated.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which are settled as a group. More specifically, a transaction is typically settled between the issuer and the interchange network, and then between the interchange network and the merchant bank (also known as the acquirer bank), and then between the merchant bank and the merchant.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

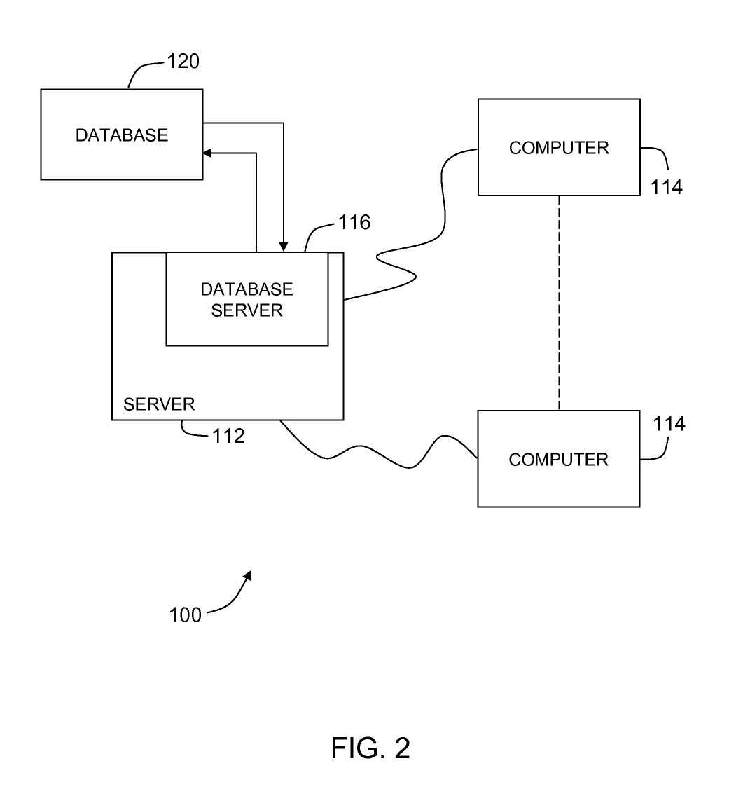

FIG. 2 is a simplified block diagram of an exemplary system 100 in accordance with one embodiment of the present invention. In one embodiment, system 100 is a payment card system used for implementing special or customized issuer-merchant relationships, and is operable to implement the modeling techniques and transaction database described herein. In addition, system 100 is operable as a payment card system, which can be utilized by users for management of accounts and payment transactions.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems and special high-speed ISDN lines. Client systems 114 could be any device capable of interconnecting to the Internet including a web-based phone, personal digital assistant (PDA), or other web-based connectable equipment. A database server 116 is connected to a database 120 containing information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

As discussed herein, database 120 stores information relating to cardholders, rewards features associated with each cardholder's payment card, and rewards data. Database 120 may also store transaction data generated as part of sales activities conducted over the bankcard network including data relating to merchants, account holders or customers, and purchases. Database 120 may also include data relating to rewards programs and special offers being made by a merchant or issuer including any empty nester rewards features associated with the payment card.

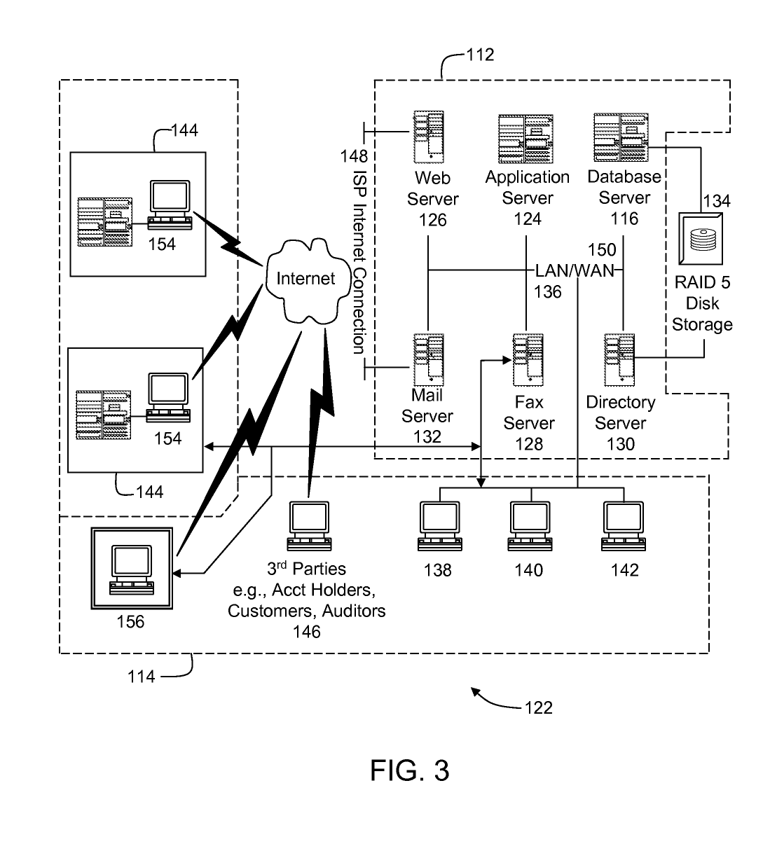

FIG. 3 is an expanded block diagram of an exemplary embodiment of a server architecture of a system 122 in accordance with one embodiment of the present invention. Components in system 122, identical to components of system 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

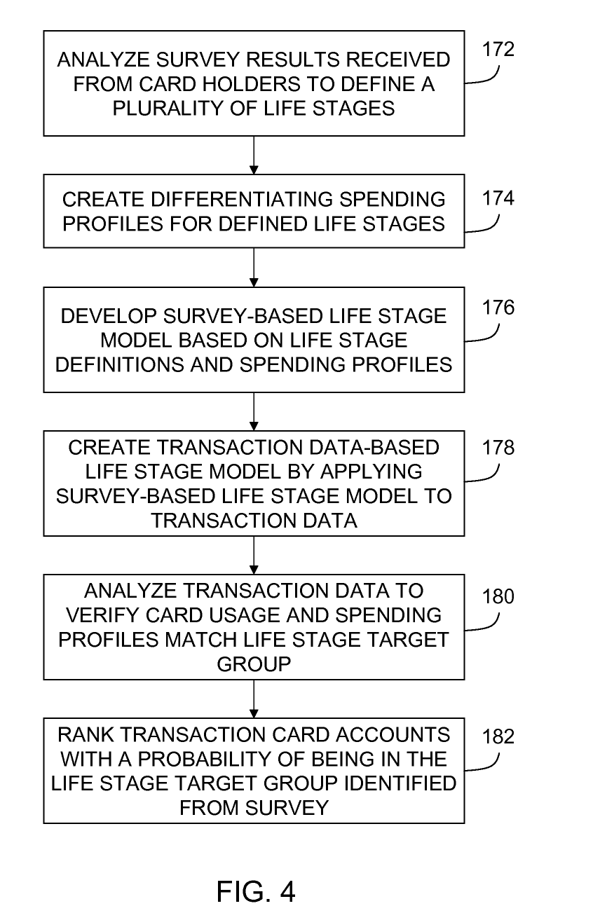

FIG. 4 is a flow chart 170 illustrating a life stage modeling process. Specifically, a computer-based method for linking transaction card accounts with at least one of a plurality of life stage segments, or defined life stages, is illustrated by the flowchart 170 of FIG. 4. The method includes analyzing 172 results from surveys received from a plurality of transaction cardholders. As further described, these survey results are utilized in the definition of life stage segments. The life stage segments are generally based on, for example, at least one of demographics, transactions within various categories that can be differentiated from one another, and transaction card usage. An example of a category is a merchant category, for example, a pharmacy and a sporting goods retailer. An example of a life stage segment is the empty nester life stage segment, which is described above. Spending profiles are created 174 based on the survey results which are then utilized in the differentiation between customers, to identify into which of the defined life stage segments they best fit.

After the life stage segments are defined, then a life stage target group can be selected, for example, by a marketing person. The life stage target group is a group of transaction card customers that fall within at least one of the defined life stages. In the example embodiment, the survey is directed to a plurality of transaction cardholders. The results of the survey are intended to allow the transaction card issuer, or a third party transaction card network (or other party marketing transaction cards and their usage), to define life stage segments (i.e., different segments of society that transaction cardholders are associated with). In addition, transaction card usage by each cardholder responding to the survey is also utilized in defining life stage segments. In other words, a life stage target group is a group of cardholders that are included within at least one defined life stage segment and is the group of cardholders that the marketer is targeting for a marketing program or campaign.

As further described below, a survey-based life stage model is then developed 176 based on a combination of a selected life stage target group and the differentiating spending profiles mentioned above. In addition, a transaction data-based life stage model is created 178 through application of the survey-based life stage model to, for example, at least a portion of the transaction data within a transaction card transaction database. In other words, life stage segments are defined through the analyzing of survey results, which generally includes at least some data related to transactions, and the transactions that are associated with a particular life stage segment are then applied to a database of transaction data. Transactions that are in the database of transaction data that are determined to be similar to the transactions that, at least in part define a life stage segment, are then utilized to associate cardholders with the corresponding life stage segment. That is, such cardholders are determined to have a higher likelihood that they belong within the particular life stage segment.

Generally, and as part of a marketing campaign, the transaction data-based life stage model is run on the transaction data 180 to identify transaction card accounts belonging to consumers that would tend to be in the selected life stage segment (the selected life stage target group). As part of the identification process, transaction card accounts represented within the database are then ranked 182 with a probability of being in the selected life stage target group Accounts with a high probability (as defined by a user) of being in the selected life stage target group are then contacted with relevant information or offers. In other words, from the transactional data and the transactional data-based life stage model, accounts presumed to be within a selected life stage target group are identified and then contacted with relevant information or offers.

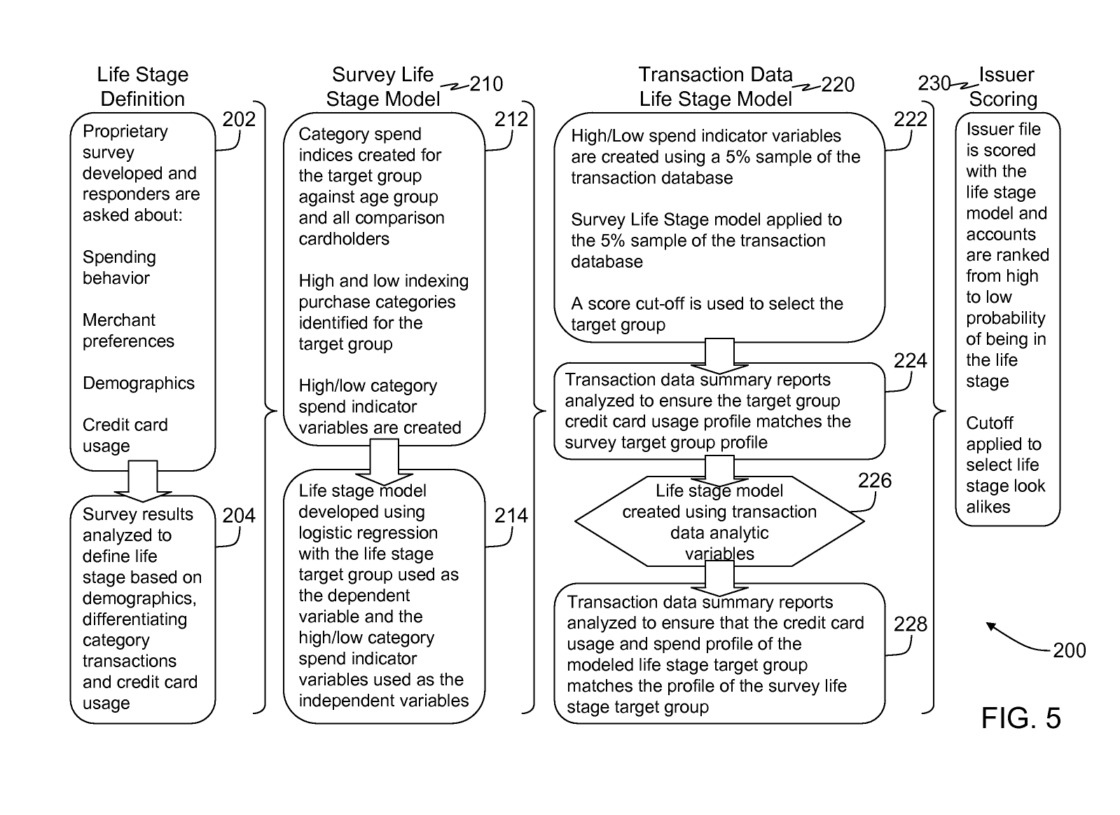

Now referring to FIG. 5, which includes a life stage model process flow chart 200, a life stage is defined 202 to include a group of consumers who are classified together based on shared demographics and through differentiating spending behaviors. In the life stage definition phase, a proprietary survey is provided to a group of responders, and the results therefrom are used to define life stage segments, from which a life stage target group may eventually be selected.

One embodiment of the survey includes self reported answers to demographic and financial transaction card usage questions. The steps associated with this phase include analyzing of survey results 204 such as self reported spending behavior, merchant preferences, demographics, and financial transaction card usage, some of which may be based on appended third party demographic data. Behaviors which may be utilized to define a desired marketing opportunity to a life stage target group, such as transactions that occur within different categories, are identified through the self reported survey responses. Responders who share the desired spending behaviors are indexed against comparison groups which include a larger universe of financial transaction card users. The index is created by calculating the spending propensities of survey responders that are determined to be in a life stage target group, and those cardholders from the larger universe that exhibit similar spending characteristics. Specifically, in the exemplary embodiment, the index illustrates high spending propensities (purchases were made in a specific merchant category (e.g., pharmacy, sporting goods) nine or more times) and low spending propensities (no purchases in the specific merchant category) for each merchant category. Table 1 below shows one sample list of merchant categories.

In one embodiment, an index score is calculated as (% of life stage target)/(% of comparison group)×100. In the embodiment, the target group is refined through an iterative process until a differentiating pattern of high (e.g., an index of 115 or above) and low (e.g., an index score of 85 or below) merchant category index scores is obtained. All responders meeting the target group criteria (the 115 or above index for example) are assigned a “1”. All other responders are assigned a “0”.

A survey life stage model 210 is defined by creating a model which identifies differentiating category spend patterns. Inputs 212 to model 210 include category spend indices that are created for an identified, or to be identified, life stage target group. These spend indices are compared against transaction data for the remainder of the transaction cardholders. Additionally, high and low indexing purchase categories are identified for the life stage target group, and both high and low category spend variables are created within the model 210.

In one embodiment, model 210 is created in part by determining a high spend propensity. This high spend propensity is based on a percentage of survey responders who answered they made a purchase in a given merchant category nine or more times for the life stage target group and for example, comparison age groups. As described above, high spend propensity variables are created in this embodiment by assigning a “1” to all accounts indicating making nine or more transactions over a twelve month period in one or more related merchant categories. All other responders are assigned a “0”.

A low spend propensity is determined based on the percentage of responders who answered they purchased zero times or “Never” over a twelve month period. Low spend propensity variables are created by assigning a “1” to all accounts which indicated not having made a purchase in each aggregated merchant. All other responders are assigned a “0”. Next, an algorithm is created using logistic regression. The life stage target group, which is generally a user selected one of the life stage segments from the life stage definition 202 is used as dependent variables of the algorithm. The high and low spend propensity variables are used as independent variables of the algorithm.

In one embodiment, the survey-based life stage model 210 is developed 214 using logistic regression with the life stage target group used as the dependent variable and high/low category spending propensity variables are used as independent variables for the model 210.

In a transaction data life stage model 220, a sample of accounts contained within an analytic area are identified and a report of summarized prior spend and transaction activity, for example over a twelve month period, is created. Key statistics, which include the mean/average, median, minimum, maximum, and a spending distribution by merchant category are analyzed to identify cut-offs for high and low spend indicator variables.

For input 222 into model 220, high and low spend indicator variables are created based on a five percent sample of the transaction database, and the survey-based life stage model 210 is applied to the five percent sample of the transaction database, and a cut-off value is utilized to select a life stage target group. Transaction data summary reports are analyzed 224 to ensure the target group credit card profile matches the survey target group profile. The transaction-based life stage model 220 is created 226 using one or more analytic variables within the transaction data, and transaction data summary reports are analyzed 228 to ensure that the financial transaction card usage and spend profile of the modeled life stage target group matches the profile of the life stage target group.

In one embodiment, high spend propensity variables are created by assigning a “1” to all accounts scoring higher than a mean spend amount for a specific merchant category. Such propensity variables also correspond to a number of transactions in a merchant category that place the account in a comparable percentile range as responders who indicated high spend on the survey. All other accounts are assigned a “0”. Low spend propensity variables are created by assigning a “1” to all accounts which score below the mean spend value for each merchant category and who also have made a number of transactions in the category that would place them in a comparable percentile range as those responders who indicated low spend on the survey. All other accounts are assigned a “0”.

These spending propensity variables, sometimes referred to as indicator variables, are utilized as inputs to generate a target score obtained from applying the survey-based life stage target group algorithm from the survey life stage model 210 to a universe of demographically profiled accounts. The top scoring accounts, for example the top quartile, are used as the life stage target group. Reports are generated by merchant categories, which include category spend averages, purchase clusters, and merchant spend activity. The reports are then evaluated to ensure that the target group was appropriately assigned and that the selected modeled group has a consistent pattern of spend and purchase cluster profiles with the identified life stage target group from the survey. Purchase clusters, as utilized herein, refer to actionable, demographic profiles into which cardholders are grouped. Purchase clusters basically show a customer's propensity for specific products and services (e.g., a propensity to buy from certain merchant categories).

The identified target group in the previous step is then used as a dependent variable in a model which uses transaction data to rank and score life stage target group look-a-likes from a specified issuer universe. The issuer universe is enhanced with demographic data which is used to filter the eligible accounts for inclusion in the final model calibration data set.

The transaction data-based life stage model 220 is a predictive model that is created, in one embodiment, as described in the following paragraphs.

In regard to predictive modeling, such a model is developed to predict an “effect”, and typically involves identification of factors that significantly impact the effect being studied (root causes and/or symptoms), as well as the manner or “direction” in which such factors have an impact (positive or negative) on the direction and the extent or “weight” of impact of these factors. A robust model typically demonstrates stability in the direction of impact and weights of the significant factors. Usage of “development” and “validation” samples facilitates assessment of model stability. A predictive model is deployed as a “score” derived from the factor values and weights. The score helps “rank-order” a given population based on the expected “probability” or “level” of the effect.

One embodiment of the life stage model 220 described herein is based on summarized information which includes dollars spent over the prior twelve months in merchant categories, which may be aggregated for particular merchants, the number of transactions in the prior twelve months in merchant categories, purchase cluster membership, and velocity variables. In the embodiment, the transaction data-based life stage model 220 is developed using a 50/50 sample/validation split. Model development is undertaken on a 50% random sample of the data available after applying suppressions, and the remaining 50% of the data is used as a “validation” sample. To measure performance of model 220, the validation samples are divided into deciles based on score values.

With regard to a structure of model 220, the logistic regression model is built upon the dependent target group variable and assessed across separate dependent components, for example, probability model: logistic model P(Target=1).

Candidate predictor variables are also utilized within model 220. Specifically, account data relating to the financial transaction card is collected for the previous 12 month period and candidate variables are created. Examples of these candidate variables include, velocity variables for the past quarter, half-year, and year, purchase clusters, first and last dates of transactions, historical transactions (12 months), historical spend (12 months), transaction by aggregated merchant and/or category, and spend by aggregated merchant and/or category.

In a variable reduction process, candidate variables are screened and selected for model inclusion through the use of Exploratory Data Analysis (EDA). These include categorical variables such as frequency distributions and cross-tab vs. dependent variables, numeric variables such as univariate statistics, binned graphs vs. dependent variable, and further variable transformations based upon EDA of categorical and numeric variables. Variable screening and reduction candidate variables are also included such as variable clusters that are created where the strongest variable from each variable cluster is selected for model stability. An initial stepwise logistic regression is created and a further check for multi-collinearity is performed.

The model performance statistics in the following list show a high concordance, that is, an ability to accurately rank order the population, high values of Somer's D (percent concordant), Gamma (percent disconcordant), Tau-a (percent tied), and c (pairs) all denote high concordance and ranges from 0.5 to 1, where 0.5 corresponds to the model randomly predicting the response, and a 1 corresponds to the model perfectly discriminating the response. In regard to concordance and discordance, a pair is concordant if the observation with the larger value of predicted probability also has the larger value of actual response and discordant if vice-versa. A KS Statistic by decile rank is also used to assess model strength.

Model performance evaluation involves dividing the population into sub-groups (typically into deciles based on predicted score values), comparing the impact of targeting groups based on “predicted scores” vs. “no model” in capturing “actual” effect within the targeted group, for example, model lift, and comparing “actual” behavior across groups—to assess if groups with higher “predicted” scores demonstrate higher levels of the “actual” effect.

In issuer scoring 230, the transaction data-based life stage model 220 is applied to an issuer file. The selected accounts represent the highest scoring life stage model look-alikes. The steps are as follows: the life stage algorithm created for the life stage model 220 is applied to an issuer file of accounts which includes summarized information for the prior months of spending activity and all associated variables including purchase clusters and velocity variables. Accounts are scored and ranked, and a cut-off score is applied to select the top scoring life stage look-a-likes.

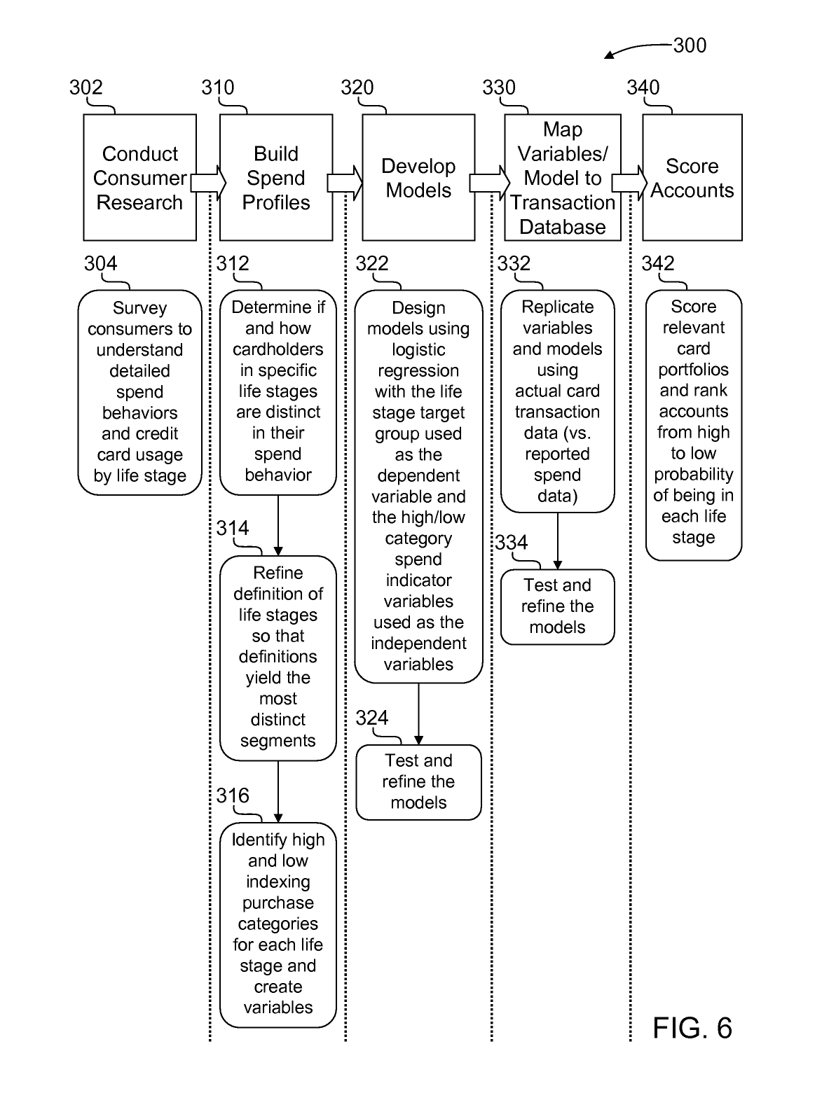

FIG. 6 is a detailed flow chart 300 providing a further illustration of the development of the life stage model described above. Referring to chart 300, customer research is conducted 302 in which customers are surveyed 304 to understand detailed spending behaviors and credit card usage by life stage.

To build 310 spending profiles, it is determined 312 if and how cardholders in specific life stages are distinct in their spending behavior. Definitions of life stages are refined 314 so that definitions yield the most distinct life stage segments. High and low indexing purchase categories are identified 316 for each life stage and variables are created.

Models are developed 320. More specifically, models are designed 322 using logistic regression with the life stage target group used as the dependent variable and the high/low category spend indicator variables used as the independent variables. The designed 322 models are then tested 324 and refined, if necessary. Variables are then mapped 330 from the model to a database of financial transaction card transactions. Variables and models are replicated 332 using actual financial transaction card data (as opposed to reported spending data from the customer survey). The models are once again tested 334 and refined if necessary.

Accounts are then scored 340. More specifically, relevant card portfolios are scored 342 and accounts ranked from a high probability to a low probability of being in one of the defined life stages.

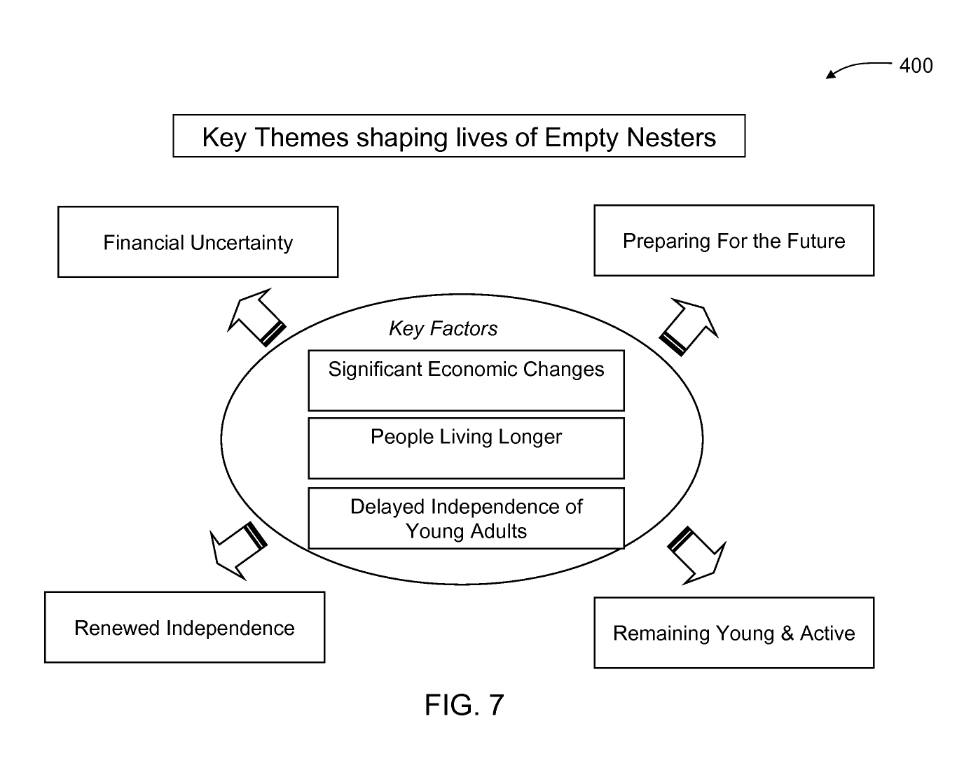

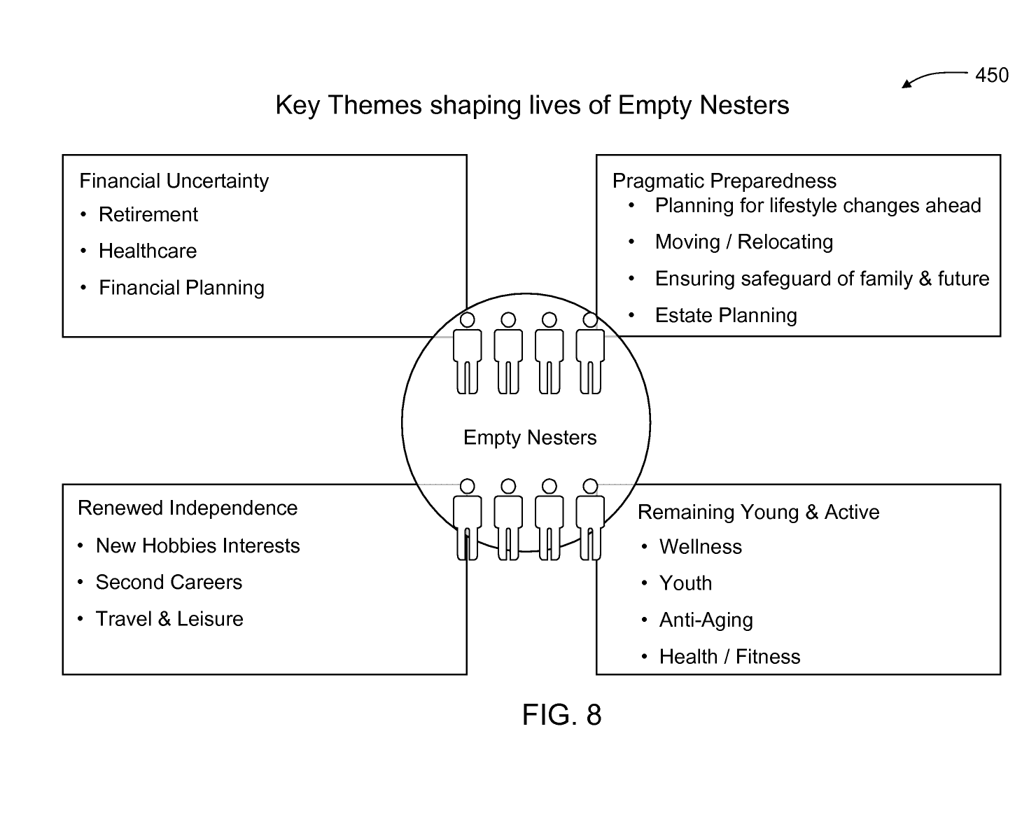

FIGS. 7 through 16 describe key themes considered in developing a payment card having rewards features directed to an empty nester segment of society. As described above, cardholder accounts with a high probability (as defined by a user) of being in a selected life stage target group may be contacted with relevant information or offers, such as, information or offers on payment cards having rewards features directed to the empty nester segment of society. For example, FIG. 7 is a diagram 400 and FIG. 8 is a diagram 450 showing key themes considered in developing a payment card having rewards features directed to an empty nester segment of society. These are themes that have been identified as being important to the empty nester segment of society. The themes include: (1) financial uncertainty; (2) pragmatic preparedness (i.e., preparing for the future); (3) renewed independence; and (4) remaining young and active. Each theme includes certain sub-categories that may also be important to empty nesters. For example, FIG. 5 shows the sub-categories listed under financial uncertainty as retirement, healthcare, and financial planning. The sub-categories listed under pragmatic preparedness are planning for lifestyle changes ahead, moving/relocating, ensuring safeguard of family and future, and estate planning. The sub-categories listed under renewed independence are new hobbies and interests, second careers, and travel and leisure. The sub-categories listed under remaining young and active are wellness, youth, anti-aging, and health and fitness. These are key themes shaping the lives of empty nesters.

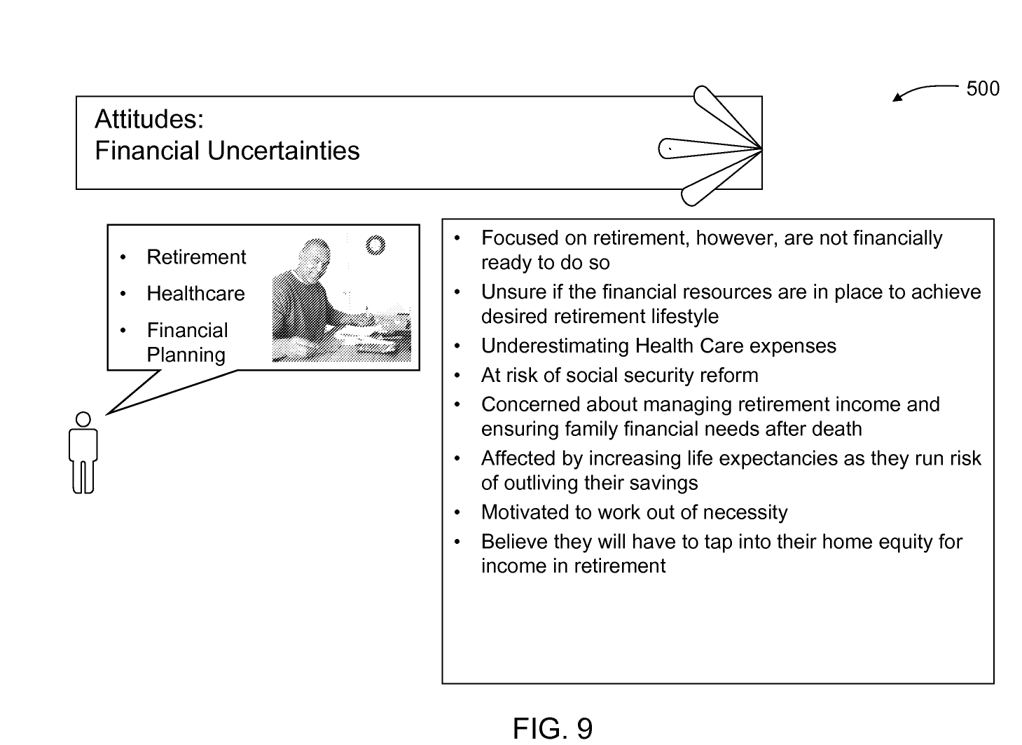

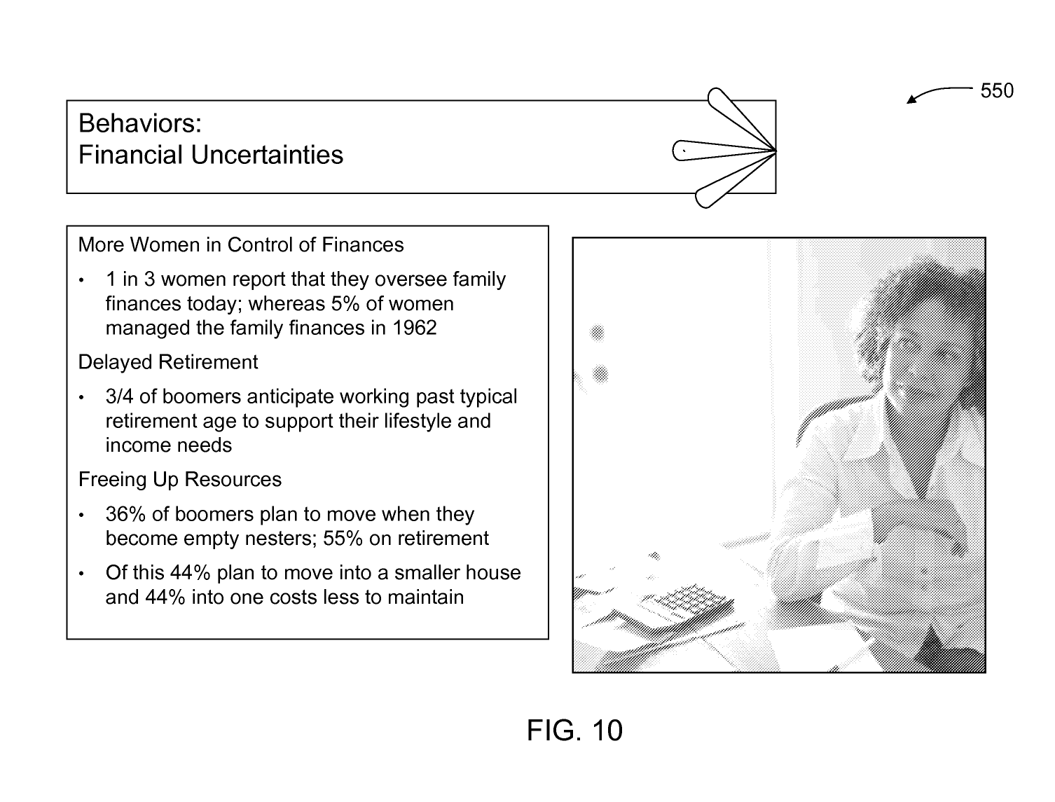

FIG. 9 is a diagram 500 showing financial uncertainty attitudes of consumers included within an empty nester segment of society that are considered in developing a payment card having rewards features directed to the empty nester segment of society. FIG. 10 is a diagram 550 showing financial uncertainty behaviors of consumers included within an empty nester segment of society that are considered in developing a payment card having rewards features directed to the empty nester segment of society.

For example, FIG. 9 lists attitudes of empty nesters relating to financial uncertainties as focused on retirement, however, are not financially ready to do so; unsure if the financial resources are in place to achieve desired retirement lifestyle; underestimating health care expenses; at risk of social security reform; concerned about managing retirement income and ensuring family financial needs after death; affected by increasing life expectancies as they run risk of outliving their savings; motivated to work out of necessity; and believe they will have to tap into their home equity for income in retirement. FIG. 10 lists behaviors of empty nesters relating to financial uncertainties as more women in control of finances: 1 in 3 women report that they oversee family finances today, whereas 5% of women managed the family finances in 1962; delayed retirement: ¾ of boomers anticipate working past typical retirement age to support their lifestyle and income needs; and freeing up resources: 36% of boomers plan to move when they become empty nesters and 55% on retirement, and of this 44% plan to move into a smaller house and 44% into one that costs less to maintain.

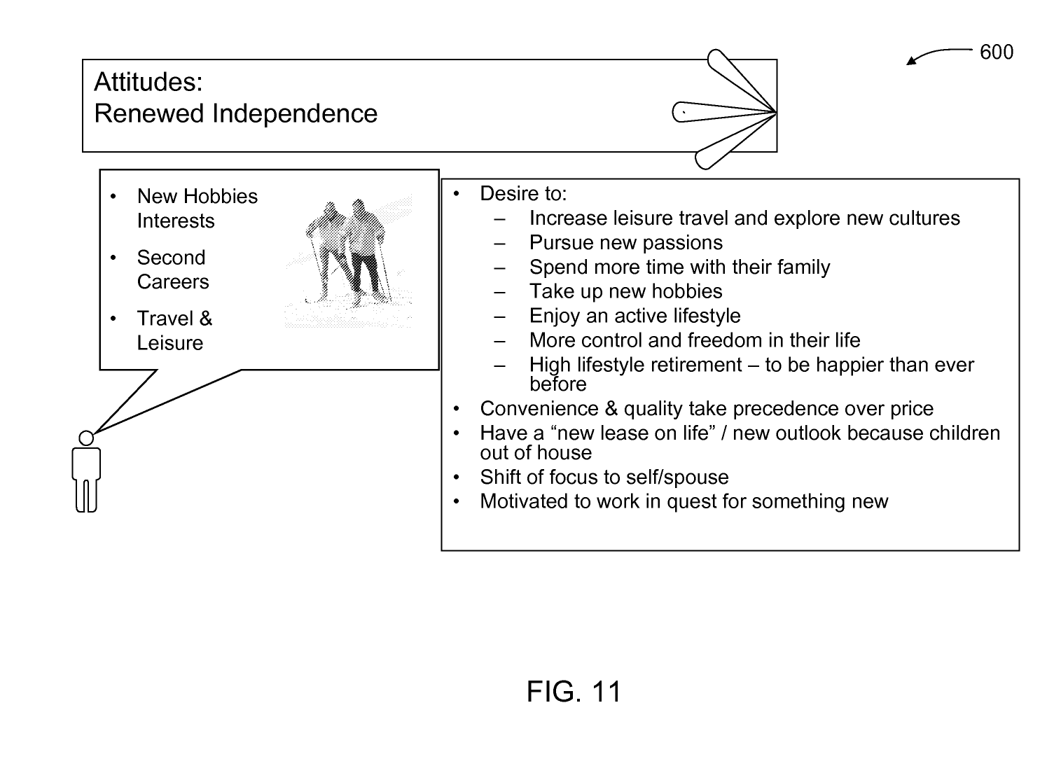

FIG. 11 is a diagram 600 showing renewed independence attitudes of consumers included within an empty nester segment of society that are considered in developing a payment card having rewards features directed to the empty nester segment of society. For example, FIG. 11 lists attitudes of empty nesters relating to renewed independence as a desire to: increase leisure travel and explore new cultures, pursue new passions, spend more time with their family, take up new hobbies, enjoy an active lifestyle, more control and freedom in their life, and high lifestyle retirement to be happier than ever before. FIG. 11 further lists attitudes of empty nesters relating to renewed independence as convenience and quality take precedence over price; have a “new lease on life” /new outlook because children out of house; shift of focus to self/spouse; and motivated to work in quest for something new.

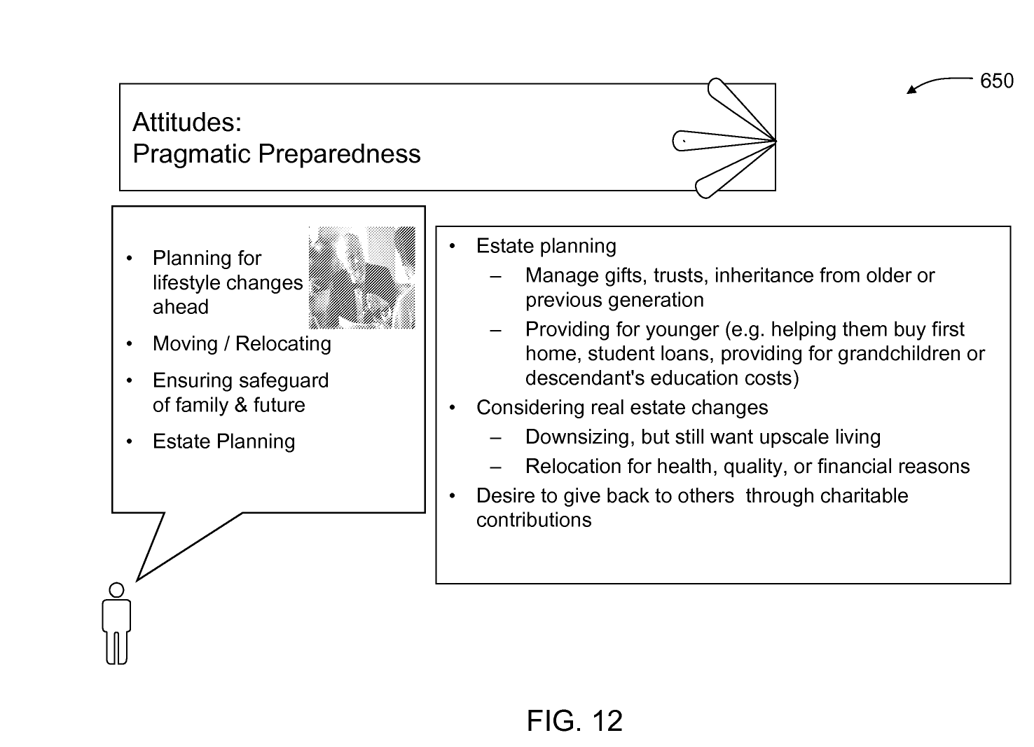

FIG. 12 is a diagram 650 showing pragmatic preparedness attitudes of consumers included within an empty nester segment of society that are considered in developing a payment card having rewards features directed to the empty nester segment of society. For example, FIG. 12 lists attitudes of empty nesters relating to pragmatic preparedness as estate planning including manage gifts, trusts, inheritance from older or previous generation, and provide for younger generation (e.g., helping them buy first home, student loans, providing for grandchildren or descendant's education costs). FIG. 12 further lists attitudes of empty nesters relating to pragmatic preparedness as considering real estate changes including downsizing but still wanting upscale living, and relocation for health, quality, or financial reasons; and desire to give back to others through charitable contributions.

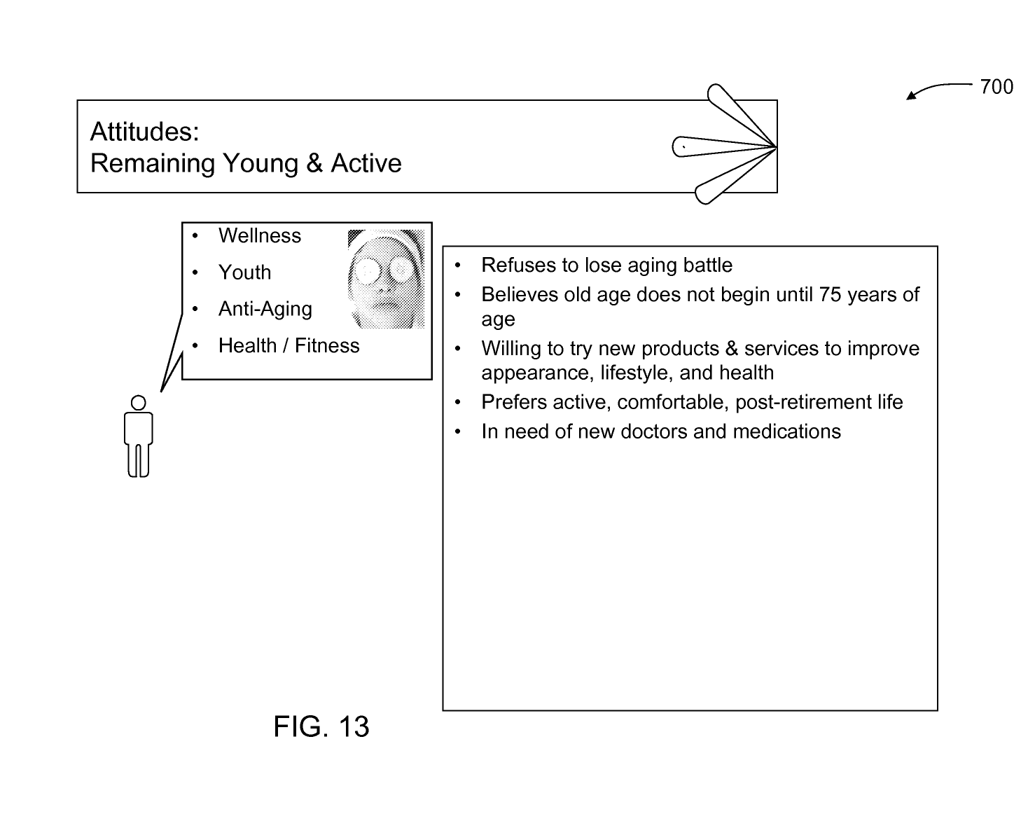

FIG. 13 is a diagram 700 showing remaining young and active attitudes of consumers included within an empty nester segment of society that are considered in developing a payment card having rewards features directed to the empty nester segment of society. For example, FIG. 13 lists attitudes of empty nesters relating to remaining young and active as refuses to lose aging battle; believes old age does not begin until 75 years of age; willing to try new products and services to improve appearance, lifestyle, and health; prefers active, comfortable, post-retirement life; and in need of new doctors and medications.

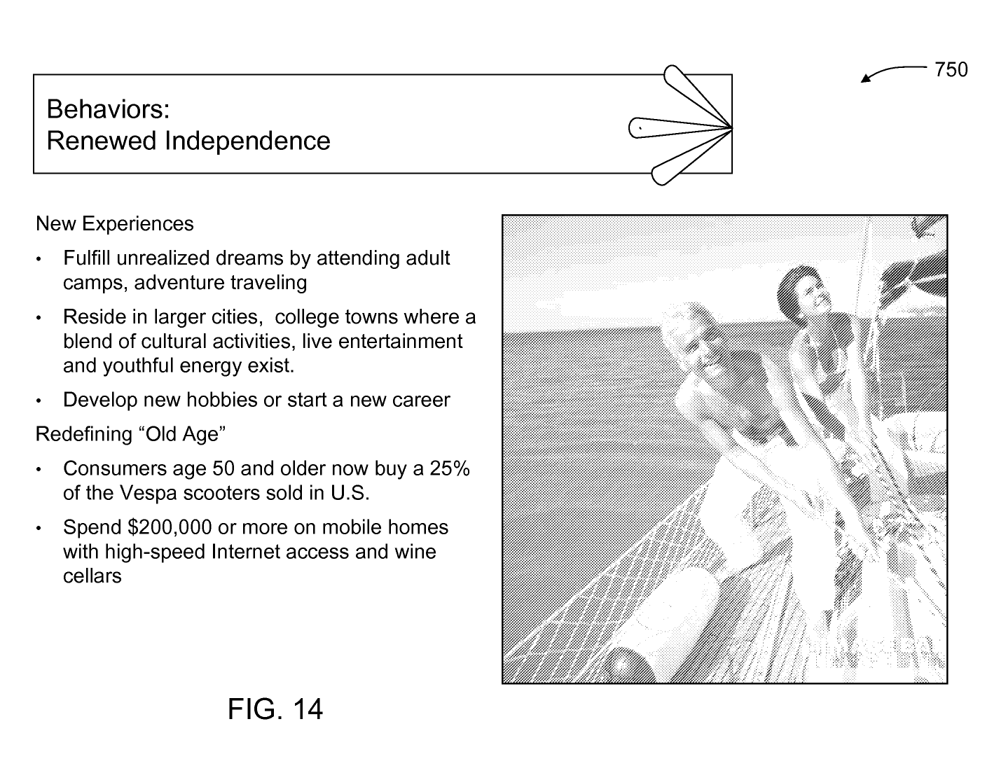

FIG. 14 is a diagram 750 showing renewed independence behaviors of consumers included within an empty nester segment of society that are considered in developing a payment card having rewards features directed to the empty nester segment of society. For example, FIG. 14 lists behaviors of empty nesters relating to renewed independence as new experiences including fulfill unrealized dreams by attending adult camps, and adventure traveling; reside in larger cities, college towns where a blend of cultural activities, live entertainment and youthful energy exist; and develop new hobbies or start a new career. FIG. 14 further lists behaviors of empty nesters relating to renewed independence as redefining “Old Age” including consumers age 50 and older now buy 25% of the Vespag scooters sold in U.S.; and spend $200,000 or more on mobile homes with high-speed Internet access and wine cellars. (Vespa is a registered trademark of Piaggio USA, Inc.).

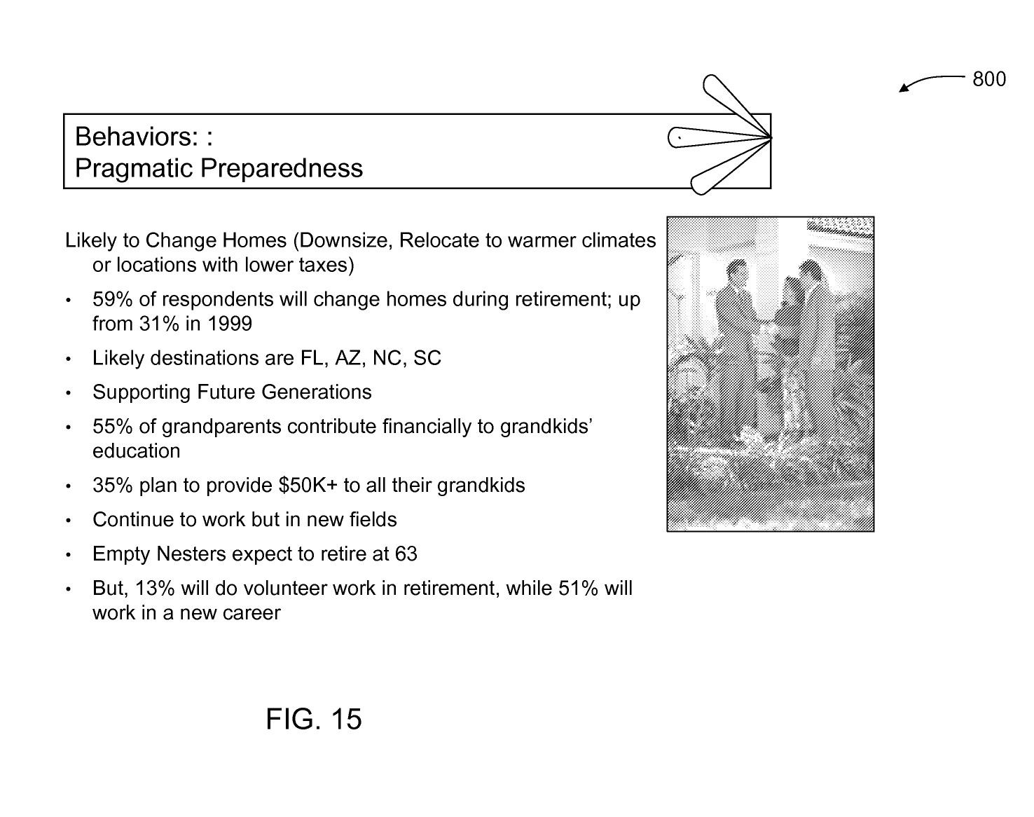

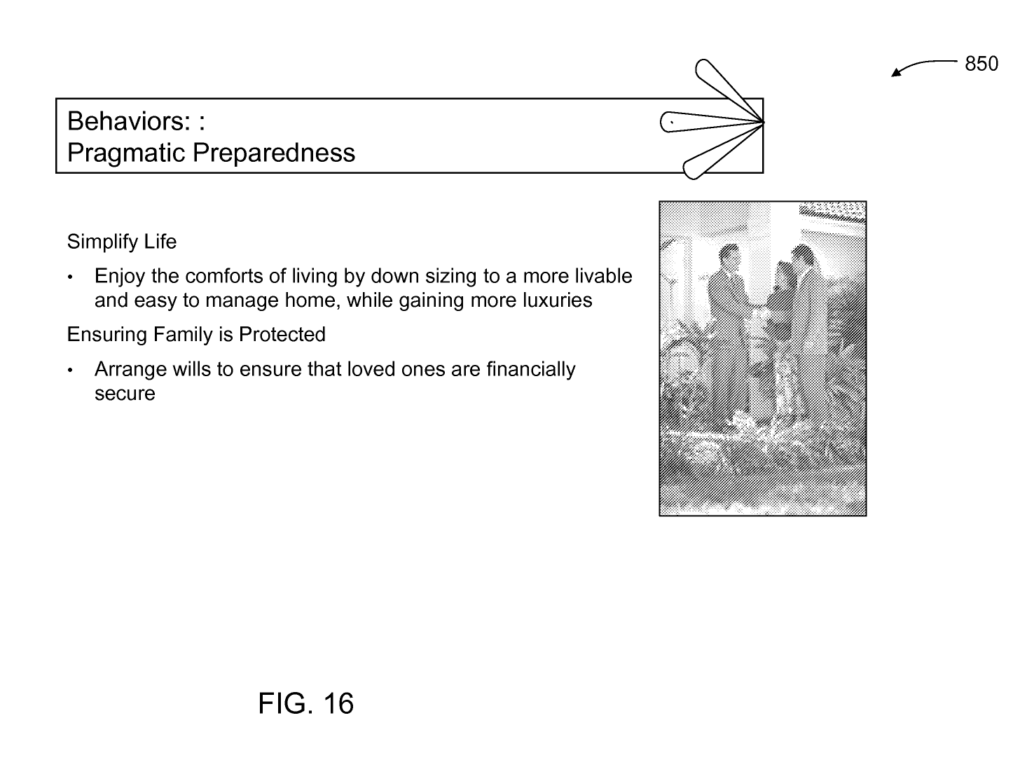

FIGS. 15 and 16 are diagrams 800 and 850, respectively, showing pragmatic preparedness behaviors of consumers included within an empty nester segment of society that are considered in developing a payment card having rewards features directed to the empty nester segment of society. For example, FIG. 15 lists behaviors of empty nesters relating to pragmatic preparedness as likely to change homes (downsize, relocate to warmer climates or locations with lower taxes), more specifically, 59% of respondents will change homes during retirement which is up from 31% in 1999; likely destinations are FL, AZ, NC, and SC; supporting future generations; 55% of grandparents contribute financially to grandkids' education; 35% plan to provide $50K+ to all their grandkids; continue to work but in new fields; empty nesters expect to retire at 63; but, 13% will do volunteer work in retirement, while 51% will work in a new career. FIG. 16 further lists behaviors of empty nesters relating to pragmatic preparedness as simplify life including enjoy the comforts of living by down sizing to a more livable and easy to manage home, while gaining more luxuries; and ensuring family is protected including arranging wills to ensure that loved ones are financially secure.

The payment card described herein, as well as the systems and processes for enrolling a user into the payment card programs described herein, have associated therewith certain rewards features that address the themes, attitudes and behaviors of the empty nester segment of society as described above. For example, the payment card described herein includes at least the following rewards features: (a) Health and Wellness (e.g., cardholders within the empty nester payment card program save money at thousands of fitness clubs, chiropractors, alternative health providers and weight loss facilities; (b) Prescription Discount Drug Program (e.g., cardholders save money on generic and brand name drugs at certain pre-designated pharmacy locations) (c) Health Discount Program (e.g., cardholders receive discounted access to leading programs including health, dental and vision care provider networks); (d) Travel Fare Alerts (e.g., cardholders receive email alerts when your chosen price becomes available on your selected routes); (e) Family Travel Planner (e.g., cardholders have access to dedicated specialists to help the cardholder plan trips); (f) Personal Assistant (e.g., cardholders are provided assistance for day chores and tasks); (g) Financial Consultant (erg., cardholder receives financial advice from financial professionals); and (h) Special Occasion Reminders/Important Dates (e.g., cardholders receive email reminders of birthdays, anniversaries and other special dates as well as opportunity to purchase gift cards in advance).

The systems and processes described herein facilitate, for example, determination of a customer's propensity to be in a given life stage using a modeling process. More specifically, the exemplary embodiments of systems and processes described herein include identifying consumer included within the empty nester life stage by analyzing collected transactional data of those consumers. The exemplary embodiments also provide a payment card program having rewards features and capabilities directed to an empty nester or a group of empty nesters. Furthermore, the exemplary systems and methods are used for enrolling a user into a payment card program that includes rewards features that are directed to an empty nester segment of society. The exemplary systems and methods are also used for processing a transaction using the empty nester payment card.

A technical effect of the systems and processes described herein include at least one of (a) defining one or more life stage segments using survey results received from a subset of customers that have an account related to a financial transaction card, (b) identifying self reported spending information in the survey results that can be used as a common variable between the survey results and a database of transactions related to the financial transaction card, (c) using a processing device to create and use a logistic regression model to link consumers to one or more of the defined life stage segments based on the database of transactions, (d) creating a behavioral model, based on transaction data, that predicts the probability that a consumer account is associated with a customer in a specific life stage segment, and (e) development of a process to apply the behavioral model, for example, in the marketing of financial products.

After the modeling identifies certain consumers as being included within an empty nester life stage segment, the systems and processes then include directing a payment card program having rewards features and capabilities directed to empty nesters. The payment card has associated therewith certain rewards features that have been determined to be desirable by the empty nester segment of society because these rewards features address many of the needs of this particular segment of society. The example embodiment of this process includes at least one of (a) providing a financial transaction payment system that includes a processing unit, an application program for execution on the processing unit, and a database for storing information relating to cardholders, rewards features associated with each cardholder's payment card, and rewards data; (b) offering a payment card having at least one rewards feature directed to an empty nester segment of society, wherein the empty nester payment card has associated therewith a financial account in a financial institution, and wherein the rewards features include at least one of a health and wellness feature, a prescription discount drug program feature, a health discount program feature, a travel fare alerts feature, a family travel planner feature, a personal assistant feature, a financial consultant feature, and a special occasion reminder feature; (c) registering within the financial transaction payment system users that accept the payment card offering by storing in the database each empty nester cardholder and each rewards feature associated with each empty nester payment card; (d) engaging in a transaction by a cardholder using a payment card; (e) processing the transaction over the financial transaction payment system; (f) determining whether the cardholder engaging in the transaction is registered within the database as an empty nester cardholder and whether the payment card used has an empty nester rewards feature associated therewith; (g) updating the rewards data stored within the database to include the transaction if the cardholder is a registered empty nester cardholder; and (h) providing a reward to the empty nester cardholder based on the updated rewards data stored within the database.

While the invention has been described in terms of various specific embodiments, those skilled in the art will recognize that the invention can be practiced with modification within the spirit and scope of the claims.

TABLE 1
Aggregated Merchant Categories

| INDUSTRY | INDUSTRY NAME |
|---|---|
| AAC | Children's Apparel |
| AAF | Family Apparel |
| AAM | Men's Apparel |
| AAW | Women's Apparel |
| AAX | Miscellaneous Apparel |
| ACC | Accommodations |
| ACS | Automotive New and Used Car Sales |
| ADV | Advertising Services |
| AFH | Agriculture/Forestry/Fishing/Hunting |
| AFS | Automotive Fuel |
| ALS | Accounting and Legal Services |
| ARA | Amusement, Recreation Activities |
| ART | Arts and Crafts Stores |
| AUC | Automotive Used Only Car Sales |
| AUT | Automotive Retail |
| BKS | Book Stores |
| BMV | Music and Videos |
| BNM | Newspapers and Magazines |
| BTN | Bars/Taverns/Nightclubs |
| BWL | Beer/Wine/Liquor Stores |
| CCR | Consumer Credit Reporting |
| CEA | Consumer Electronics/Appliances |
| CES | Cleaning and Exterminating Services |
| CGA | Casino and Gambling Activities |
| CMP | Computer/Software Stores |
| CNS | Construction Services |
| COS | Cosmetics and Beauty Services |
| CPS | Camera/Photography Supplies |
| CSV | Courier Services |
| CTE | Communications, Telecommunications Equipment |
| CTS | Communications, Telecommunications, Cable |
| | Services |
| CUE | College, University Education |
| CUF | Clothing, Uniform, Costume Rental |
| DAS | Dating Services |
| DCS | Death Care Services |
| DIS | Discount Department Stores |
| DLS | Drycleaning, Laundry Services |
| DPT | Department Stores |
| DSC | Drug Store Chains |
| DVG | Variety/General Merchandise Stores |
| EAP | Eating Places |
| ECA | Employment, Consulting Agencies |
| EHS | Elementary, Middle, High Schools |
| EQR | Equipment Rental |
| ETC | Miscellaneous |
| FLO | Florists |
| FSV | Financial Services |
| GHC | Giftware/Houseware/Card Shops |
| GRO | Grocery Stores |
| GSF | Specialty Food Stores |
| HBM | Health/Beauty/Medical Supplies |
| HCS | Health Care and Social Assistance |
| HFF | Home Furnishings/Furniture |
| HIC | Home Improvement Centers |
| INS | Insurance |
| IRS | Information Retrieval Services |
| JGS | Jewelry and Giftware |
| LEE | Live Performances, Events, Exhibits |
| LLS | Luggage and Leather Stores |
| LMS | Landscaping/Maintenance Services |
| MAS | Miscellaneous Administrative and Waste Disposal |
| | Services |
| MER | Miscellaneous Entertainment and Recreation |
| MES | Miscellaneous Educational Services |
| MFG | Manufacturing |
| MOS | Miscellaneous Personal Services |
| MOT | Movie and Other Theatrical |
| MPI | Miscellaneous Publishing Industries |
| MPS | Miscellaneous Professional Services |
| MRS | Maintenance and Repair Services |
| MTS | Miscellaneous Technical Services |
| MVS | Miscellaneous Vehicle Sales |
| OPT | Optical |
| OSC | Office Supply Chains |
| PCS | Pet Care Services |
| PET | Pet Stores |
| PFS | Photofinishing Services |
| PHS | Photography Services |
| PST | Professional Sports Teams |
| PUA | Public Administration |
| RCP | Religious, Civic and Professional Organizations |
| RES | Real Estate Services |
| SGS | Sporting Goods/Apparel/Footwear |
| SHS | Shoe Stores |
| SND | Software Production, Network Services and Data |
| | Processing |
| SSS | Security, Surveillance Services |
| TAT | Travel Agencies and Tour Operators |
| TEA | T + E Airlines |
| TEB | T + E Bus |
| TET | T + E Cruise Lines |
| TEV | T + E Vehicle Rental |
| TOY | Toy Stores |
| TRR | T + E Railroad |
| TSE | Training Centers, Seminars |
| TSS | Other Transportation Services |
| TTL | T + E Taxi and Limousine |
| UTL | Utilities |
| VES | Veterinary Services |
| VGR | Video and Game Rentals |
| VTB | Vocation, Trade and Business Schools |
| WAH | Warehouse |
| WHC | Wholesale Clubs |
| WHT | Wholesale Trade |

What is claimed is:

1. A computer-based method for enrolling financial transaction cardholders into a payment card program that includes features that are directed to an empty nester segment of society, said method performed using a computer system coupled to a database, said method comprising:
creating at least one spending profile representing an empty nester target group, the empty nester target group including transaction cardholders within the empty nester segment of society targeted for receiving a marketing campaign;
storing in the database transaction data for transaction card accounts, the transaction data including data relating to each cardholder associated with a transaction card account and purchases made by the cardholders using the corresponding transaction card;
identifying cardholders included within the empty nester target group by comparing the transaction data to the at least one empty nester spending profile; and
offering a payment card program having at least one rewards feature directed to the empty nester segment of society to the cardholders identified as being within the empty nester target group.

2. A computer-based method in accordance with claim 1 further comprising at least one of:
storing in the database survey data collected from a plurality of financial transaction cardholders; and
analyzing the survey data to define the empty nester target group based on at least one of demographics, transactions within various categories, and transaction card usage.

3. A computer-based method in accordance with claim 1, wherein offering a payment card program having at least one rewards feature directed to an empty nester target group comprises offering an empty nester payment card program having associated therewith a financial account in a financial institution, and wherein the at least one rewards feature includes at least one of a health and wellness feature, a prescription discount drug program feature, a health discount program feature, a travel fare alerts feature, a family travel planner feature, a personal assistant feature, a financial consultant feature, and a special occasion reminder feature.

4. A computer-based method in accordance with claim 1 further comprising, providing a financial transaction payment system that includes a processing unit, an application program for execution on the processing unit, and a database for storing information relating to cardholders, rewards features associated with each cardholder's payment card, and rewards data.

5. A computer-based method in accordance with claim 4 further comprising, enrolling within the financial transaction payment system, transaction cardholders that accept the payment card offering, by storing in the database each empty nester cardholder and each rewards feature associated with each empty nester payment card.

6. A computer-based method in accordance with claim 1 further comprising, enabling the empty nester cardholders to access the at least one rewards feature associated with the payment card and the rewards data through a remote system.

7. A computer-based method in accordance with claim 2 wherein analyzing survey data received from a plurality of transaction cardholders comprises at least one of:
utilizing a proprietary survey to define the empty nester target group; and
receiving survey data that includes self reported answers to questions relating to at least one of spending behavior, merchant preferences, demographics, and transaction card utilization.

8. A computer-based method in accordance with claim 1 wherein creating at least one spending profile representing an empty nester target group comprises:
identifying spending propensities that potentially define a desired marketing opportunity using the survey data; and
determining which transaction card account holders exhibit similar spending characteristics by analyzing the transaction data stored in the database.

9. A computer for enrolling financial transaction cardholders into a payment card program that includes features that are directed to an empty nester segment of society, said computer coupled to a database, said computer configured to:
store in said database at least one spending profile representing the empty nester segment of society;
store in said database transaction data for a plurality of financial transaction cardholders;
identify which of the plurality of financial transaction cardholders are included within the empty nester segment of society by comparing the transaction data to the at least one spending profile;
prompt a user to offer a payment card having at least one rewards feature directed to the empty nester segment of society to the cardholders identified as being within the empty nester segment of society; and
register each cardholder that accepts the payment card offering.

10. A computer in accordance with claim 9, wherein said computer is farther configured to store in said database survey data collected from the plurality of financial transaction cardholders and to create the at least one spending profile representing the empty nester segment of society based on the survey data.

11. A computer in accordance with claim 10, wherein the at least one spending profile representing the empty nester segment of society is based on one or more key themes determined to be important to empty nesters, the key themes comprising: financial uncertainty, pragmatic preparedness, renewed independence, and remaining young and active.

12. A computer in accordance with claim 1 0, wherein to create at least one spending profile representing an empty nester segment of society based on the survey data, said computer is configured to define the empty nester life stage based on at least one of demographics, transactions within differentiating categories, and transaction card usage.

13. A computer in accordance with claim 10, wherein the at least one spending profile representing the empty nester segment of society includes collected survey data of financial transactions related to one or more of: retirement, healthcare, financial planning, moving/relocating, estate planning, new hobbies, new interests, second careers, travel, leisure, wellness, anti-aging, health, and fitness.

14. A computer in accordance with claim 9, wherein said computer is further configured to identify common variables between the stored survey data and said database of financial transaction card transaction data to identify which of the plurality of the financial transaction cardholders are within the empty nester segment of society.

15. A computer in accordance with claim 14, wherein said computer is further configured to create and utilize logistic regression models that incorporate the stored survey data, the financial transaction card transaction data, and the identified common variables to identify which of the plurality of financial transaction cardholders are within the empty nester segment of society.

16. A computer in accordance with claim 15, wherein to create and utilize logistic regression models, said computer is configured to:
develop a survey-based life stage model based on a combination of a defined life stage segment and differentiating spending profiles gleaned from the received survey data; and
create a transaction data-based life stage model through application of the survey-based life stage model to a portion of the transaction data within the database of financial transaction card transaction data.

17. A computer in accordance with claim 9, wherein said computer is further configured to store in said database information identifying each empty nester cardholder that accepts the payment card offering and the rewards features associated with each accepted payment card.

18. A computer in accordance with claim 9, wherein the at least one rewards feature comprises at least one of a health and wellness feature, a prescription discount drug program feature, a health discount program feature, a travel fare alerts feature, a family travel planner feature, a personal assistant feature, a financial consultant feature, and a special occasion reminder feature.

19. A computer in accordance with claim 9, wherein said computer is further configured to verify a correlation between the financial transaction card usage and the at least one empty nester spending profile, said computer further configured to predict a probability that a financial transaction card account user is included within the defined empty nester segment of society.

20. A computer in accordance with claim 9, wherein said computer is further configured to assign transaction card accounts represented within said database of financial transaction card transaction data with a probability of being used by a cardholder in the empty nester segment of society.

21. A computer in accordance with claim 9, wherein said computer is further configured to:
engage in a transaction by a cardholder using a payment card;
process the transaction over a financial transaction payment system;
determine whether the cardholder engaging in the transaction is registered within said database as an empty nester cardholder and whether the payment card used has an empty nester rewards feature associated therewith;
update the rewards data stored within the database to include the transaction if the cardholder is a registered empty nester cardholder; and
provide a reward to the empty nester cardholder based on the updated rewards data stored within the database.

22. A network based system for enrolling financial transaction cardholders into a payment card program that includes features that are directed to an empty nester segment of society, said system comprising:
a client system;
a centralized database for storing information; and
a server system configured to be coupled to said client system and said database, said server system further configured to:
store in said database at least one spending profile representing the empty nester segment of society;
store in said database transaction data for a plurality of financial transaction cardholders;
identify which of the plurality of financial transaction cardholders are included within the empty nester segment of society by comparing the transaction data to the at least one spending profile;
prompt a user to offer a payment card having at least one rewards feature directed to the empty nester segment of society to the cardholders identified as being within the empty nester segment of society; and
register each cardholder that accepts the payment card offering.

23. A system in accordance with claim 22, wherein said server system is further configured to store in said database survey data collected from the plurality of financial transaction cardholders and to create the at least one spending profile representing the empty nester segment of society based on the survey data.

24. A system in accordance with claim 22, wherein said server system is further configured to identify common variables between the stored survey data and said database of financial transaction card transaction data to identify which of the plurality of the financial transaction cardholders are within the empty nester segment of society.

25. A system in accordance with claim 22, wherein the at least one rewards feature includes at least one of a health and wellness feature, a prescription discount drug program feature, a health discount program feature, a travel fare alerts feature, a family travel planner feature, a personal assistant feature, a financial consultant feature, and a special occasion reminder feature.

26. A system in accordance with claim 22, wherein said client system comprises a point-of-sale terminal configured to collect account information from a consumer and communicate with said server system.

27. A computer program embodied on a computer readable medium for enrolling financial transaction cardholders into a payment card program that includes features that are directed to an individual included in an empty nester life stage segment, said program comprising at least one code segment that:
utilizes survey result data received from a plurality of financial transaction cardholders to define an empty nester life stage segment;
identifies survey result data that can be utilized as common variables between the survey result data and a database of financial transaction card transaction data;
defines a spending profile representing the empty nester life stage segment based on the common variables;
creates a transaction data-based empty nest life stage model through a comparison of the defined spending profile to at least a portion of the financial transaction card transaction data; and
utilizes the transaction data-based empty nest life stage model to identify a cardholder associated with the financial transaction card transaction data that is within the empty nester life stage segment.

28. A computer program in accordance with claim 27 further comprising at least one code segment that prompts a user to offer a payment card to the cardholder identified as being within the empty nester life stage segment, the payment card having at least one rewards feature directed to cardholders within the empty nester life stage segment.

29. A computer program in accordance with claim 28, wherein the at least one rewards feature comprises at least one of a health and wellness feature, a prescription discount drug program feature, a health discount program feature, a travel fare alerts feature, a family travel planner feature, a personal assistant feature, a financial consultant feature, and a special occasion reminder feature.

30. A computer program in accordance with claim 27 further comprising at least one code segment that registers each cardholder that accepts the payment card offering by storing in a database information identifying each empty nester cardholder that accepts the payment card offering and the rewards features associated with each accepted payment card.

31. A computer program in accordance with claim 27, wherein the defined spending profile representing the empty nester life stage segment is based on one or more key themes determined to be important to empty nesters, the key themes comprising: financial uncertainty, pragmatic preparedness, renewed independence, and remaining young and active.

32. A computer program in accordance with claim 27, wherein the defined spending profile representing the empty nester life stage segment includes survey result data of financial transactions related to one or more of retirement, healthcare, financial planning, moving/relocating, estate planning, new hobbies, new interests, second careers, travel, leisure, wellness, anti-aging, health, and fitness.
